(19) United States
(12) Patent Application Publication
(10) Pub. No.: US 2018/0230851 A1
(43) Pub. Date: Aug. 16, 2018

(54) VARIABLE NOZZLE MECHANISM AND VARIABLE CAPACITY TURBOCHARGER

(71) Applicant: MITSUBISHI HEAVY INDUSTRIES, LTD., Tokyo (JP)

(72) Inventors: Eigo KATOU, Tokyo (JP); Keigo SAKAMOTO, Tokyo (JP); Noriyuki HAYASHI, Tokyo (JP); Hiroyuki ARIMIZU, Tokyo (JP); Nariaki SEIKE, Tokyo (JP)

(73) Assignee: MITSUBISHI HEAVY INDUSTRIES, LTD., Tokyo (JP)

(21) Appl. No.: 15/507,109

(22) PCT Filed: Nov. 21, 2014
(86) PCT No.: PCT/JP2014/080944

§ 371 Date: Feb. 27, 2017

(51) Int. Cl. F01D 17/16; F02B 37/24; F01D 9/04; F01D 9/02; F01D 25/00

(52) U.S. Cl. CPC F01D 17/165; F02B 37/24; F01D 9/041; F01D 9/026; F02C 6/12; F05D 2220/40; F05D 2260/941; F05D 2300/50212; F05D 2300/171; F01D 25/005

(57) ABSTRACT

A variable nozzle mechanism for a variable capacity turbocharger includes: a first plate having an annular shape; a second plate facing the first plate and having an annular shape, the second plate and the first plate defining an exhaust gas path in between; a plurality of nozzle vanes rotatably supported between the first plate and the second plate; and an annular member inserted on an inner circumference side of the first plate. The first plate includes a front surface facing the exhaust gas path and a back surface on an opposite side to the front surface, the annular member includes a front surface facing the exhaust gas path and a back surface on an opposite side to the front surface, and a gap is provided between the first plate and the annular member, the gap extending along a thickness direction of the first plate, from a point between an inner circumference edge of the front surface of the first plate and an outer circumference edge of the front surface of the annular member.

### TECHNICAL FIELD

The present disclosure relates to a variable nozzle mechanism and a variable capacity turbocharger.

### BACKGROUND

A variable nozzle mechanism for a variable capacity turbocharger adjusts an area of an exhaust gas path in a turbine housing to change a flowrate and pressure of exhaust gas flowing to a turbine blade, and thus achieves a higher turbocharging effect.

As illustrated in FIG. 5, the variable nozzle mechanism generally includes: a pair of annular plates 12 and 14 facing each other and defining an exhaust gas path 24 in between; and a plurality of nozzle vanes 16 rotatably supported between the pair of annular plates 12 and 14. The variable nozzle mechanism adjusts a path area of the exhaust gas path 24 by changing an angle of the plurality of nozzle vanes 16.

For example, Japanese Patent No. 5010631, filed by the present inventors, discloses an example of a turbocharger including the variable nozzle mechanism.

### CITATION LIST

### Patent Literature

### Patent Document 1: Japanese Patent No. 5010631

### SUMMARY

### Technical Problem

The present inventors have come up with the following findings. The annular plates 12 and 14 in the variable nozzle mechanism illustrated in FIG. 5 is exposed to high temperature exhaust gas when an engine is operating. Thus, when the temperature and the flowrate of the exhaust gas changes due to start/stop of the engine or the other like load change, a radial temperature distribution on the annular plates 12 and 14 is likely to be largely uneven. For example, in a portion around an inner circumference edge 12a1 of the annular plate 12 on a side of the exhaust gas path 24, two surfaces, including a surface 12a of the annular plate 12 on the side of the exhaust gas path 24 and an inner circumference surface 12c of the annular plate 12, are exposed to the exhaust gas. Thus, when the engine starts, the temperature in the area rises quicker than other portions of the annular plate 12, and thus radial temperature distribution on the annular plate 12 is likely to be uneven as illustrated in FIG. 6 (temperature is likely to be higher at a portion further on a radially inner side).

The present inventors have further found that when thermal stress (see FIG. 7) due to such an uneven temperature distribution is repeatedly applied, fatigue damage is likely to occur in a portion of the annular plate 12, 14 around the inner circumference edge on the side of the exhaust gas path 24. In an area between the inner circumference edge 12a1 and a supporting hole 12h on the annular plate 12 provided with the supporting hole 12h for rotatably supporting the nozzle vane 16, stress is likely to be large as illustrated in FIG. 7 and the fatigue damage is likely to occur (see FIG. 8).

Patent Document 1 discloses no configuration for preventing the fatigue damage from occurring in the portion around the inner circumference edge of the annular plate on a side of the exhaust gas path, and does not even mention about the problem in that the fatigue damage occurs in the portion around the inner circumference edge.

The present invention is made in view of the problem described above, and an object of the present invention is to provide a variable nozzle mechanism that can prevent, for an annular plate forming an exhaust gas path in a variable nozzle mechanism, fatigue damage from occurring in a portion of the annular plate around an inner circumference edge on a side of the exhaust gas path.

### Solution to Problem

(1) A variable nozzle mechanism for a variable capacity turbocharger according to at least one embodiment of the present invention includes: a first plate having an annular shape; a second plate facing the first plate and having an annular shape, the second plate and the first plate defining an exhaust gas path in between; a plurality of nozzle vanes rotatably supported between the first plate and the second plate; and an annular member inserted on an inner circumference side of the first plate. The first plate includes a front surface (surface on a front side) facing the exhaust gas path and a back surface on an opposite side to the front surface, the annular member includes a front surface facing the exhaust gas path and a back surface on an opposite side to the front surface, and a gap is provided between the first plate and the annular member, the gap extending along a thickness direction of the first plate, from a point between an inner circumference edge of the front surface of the first plate and an outer circumference edge of the front surface of the annular member.

In this specification, one of a “nozzle mount” and a “nozzle plate”, described in “DETAILED DESCRIPTION”, corresponds to the term “first plate” and the other one corresponds to the term “second plate”, unless noted otherwise. Thus, the variable nozzle mechanism with the configuration (1) described above, includes a mode in which the “first plate” corresponds to the “nozzle mount” and the “second plate” corresponds to the “nozzle plate”, and a mode in which the “first plate” corresponds to the “nozzle plate” and the “second plate” corresponds to the “nozzle mount”. In the description below, the terms “first plate” and “second plate” are used to indicate that the two modes described above are included, unless otherwise specified. The term “front surface” represents “a surface on the front side” and not “any surface”, unless otherwise specified.

In the variable nozzle mechanism with the configuration (1), the radial temperature distribution might be largely uneven on the first plate and the annular member due to the change in the temperature and flowrate of the exhaust gas caused by start/stop of an engine or other like load changes. Even in such a case, the first plate and the annular member thermally expand without interfering each other on the side of the front surface of the members as long as the gap is not filled. Thus, thermal stress can be effectively reduced. Thus, the fatigue damage can be prevented from occurring in the portion around the inner circumference edge of the first plate on the side of the front surface.

(2) In some embodiments, in the variable nozzle mechanism with the configuration (1) described above, the annular member includes a press fitting portion which is press fit to the first plate, at a portion further toward a side of the back surface of the annular member than the gap.

In the variable nozzle mechanism with the configuration (2) described above, the annular member can be prevented from falling off from the first plate with a simple configuration while ensuring the gap provided between the first plate and the annular member.

(3) In some embodiments, in the variable nozzle mechanism with the configuration (2) described above, the first plate has an inner circumference surface provided with a step portion against which the annular member abuts in the thickness direction of the first plate, and the press fitting portion is press fit to the first plate at a portion further toward the side of the back surface of the annular member than the step portion.

In the variable nozzle mechanism with the configuration (3) described above, the annular member can be more effectively prevented from falling off from the first plate with a simple configuration.

(4) In some embodiments, the variable nozzle mechanism with the configuration (1) described above, the first plate has an inner circumference surface provided with a step portion against which the annular member abuts in the thickness direction of the first plate, and the variable nozzle mechanism further includes a pressing member which presses the annular member toward the step portion.

In the variable nozzle mechanism with the configuration (4), the annular member can be prevented from falling off from the first plate, while ensuring the gap provided between the first plate and the annular member.

(5) In some embodiments, in the variable nozzle mechanism with the configuration (4) described above, a second gap is provided between the first plate and the annular member, the second gap extending along the thickness direction of the first plate, to the step portion from a point between the inner circumference edge of the back surface of the first plate and the outer circumference edge of the back surface of the annular member.

In the variable nozzle mechanism with the configuration (5) described above, the first plate and the annular member are press fit to each other with a gap provided entirely over the thickness direction of the first plate. Thus, the thermal stress can be more effectively reduced in the portion around the inner circumference surface of the first plate, whereby the fatigue damage can be effectively prevented from occurring in the portion around the inner circumference surface of the first plate.

(6) In some embodiments, in the variable nozzle mechanism with the configurations (3) to (5) described above, the step portion is formed entirely over the inner circumference surface of the first plate.

In the variable nozzle mechanism with the configuration (6) described above, the step portion is formed entirely over the inner circumference surface of the first plate. Thus, more uniform thermal stress can be achieved in a portion around the step portion compared with a configuration in which the step portion is formed only partially on the inner circumference surface of the first plate. Thus, the fatigue damage can be prevented from occurring in the portion around the step portion of the first plate.

(7) In some embodiments, in the variable nozzle mechanism with the configurations (1) to (6) described above, the first plate and the annular member are made of stainless steel.

In the variable nozzle mechanism with the configurations (1) to (6) described above, the fatigue damage can be prevented from occurring in the portion around the inner circumference edge of the first plate. Thus, even when the first plate and the annular member are made of stainless steel featuring a lower marital strength and a lower cost than a nickel-based alloy, as in the configuration (7) described above, the fatigue damage can be prevented from occurring in the portion around the inner circumference edge of the first plate on the side of the front surface. Thus, a manufacturing cost of the variable nozzle mechanism can be prevented from increasing, while preventing the fatigue damage from occurring in the portion around the inner circumference edge of the first plate on the side of the front surface.

(8) In some embodiments, in the variable nozzle mechanism with the configurations (1) to (7) described above, the first plate is a nozzle mount defining a hub side wall of the exhaust gas path, the second plate is a nozzle plate defining a shroud side wall of the exhaust gas path, and the first plate is provided with a plurality of supporting holes each rotatably supporting a shaft portion of a corresponding one of the plurality of nozzle vanes.

The nozzle mount defining the hub side wall of the exhaust gas path is provided with the supporting hole rotatably supporting the nozzle vane. Thus, as illustrated in FIG. 7, the stress is likely to be large and the fatigue damage is likely to occur in a portion of the nozzle mount between the inner circumference edge and the supporting hole. In view of this, the variable nozzle mechanism with the configuration (8) described above has the gap provided so that the fatigue damage can be effectively prevented from occurring even in the nozzle mount in which the fatigue damage is likely to occur as described above.

(9) In some embodiments, in the variable nozzle mechanism with the configuration (8) described above, a material forming the annular member has a smaller linear expansion coefficient than a material forming the first plate.

In the variable nozzle mechanism with the configuration (9) described above, even when the temperature of the annular member temporarily exceeds that of the nozzle mount due the operation of the engine, the thermal stress can be prevented from increasing with the difference between the annular member and the nozzle mount in a thermal deformation amount prevented from increasing. Thus, the fatigue damage can be prevented from occurring in the portion around the inner circumference edge of the nozzle mount.

(10) In some embodiments, in the variable nozzle mechanism with the configuration (9) described above, the annular member is formed of a nickel-based alloy and the first plate is formed of stainless steel.

In the variable nozzle mechanism with the configuration (10) described above, the annular member, which is relatively likely to involve high thermal stress, is made of the nickel-based alloy featuring high material strength and a high cost. The nozzle mount, which is relatively less likely to involve high thermal stress, is made of stainless steel. Thus, a manufacturing cost of the variable nozzle mechanism can be prevented from increasing, while preventing the fatigue damage from occurring in the portion around the inner circumference edge of the nozzle mount.

(11) A variable nozzle mechanism for a variable capacity turbocharger according to at least one embodiment of the present invention includes: a first plate having an annular shape; a second plate facing the first plate and having an annular shape, the second plate and the first plate defining an exhaust gas path in between; a plurality of nozzle vanes rotatably supported between the first plate and the second plate; and an annular member inserted on an inner circumference side of the first plate, wherein the first plate is a nozzle mount defining a hub side wall of the exhaust gas path, the second plate is a nozzle plate defining a shroud side wall of the exhaust gas path, the first plate is provided with a plurality of supporting holes each rotatably supporting a shaft portion of a corresponding one of the plurality of nozzle vanes, and a material forming the annular member has a smaller linear expansion coefficient than a material forming the first plate.

In the variable nozzle mechanism with the configuration (11) described above, the material forming the annular member has the smaller linear expansion coefficient than the material forming the nozzle mount. Thus, even when the temperature of the annular member temporarily exceeds that of the nozzle mount due the operation of the engine, the thermal stress can be prevented from increasing with the difference between the annular member and the nozzle mount in a thermal deformation amount prevented from increasing. Thus, the fatigue damage can be prevented from occurring in the portion around the inner circumference edge of the nozzle mount.

(12) A variable capacity turbocharger according to at least one embodiment of the present invention includes: a turbine rotor; a turbine housing which accommodates the turbine rotor, and defines a scroll flow path into which exhaust gas from an engine flows; and the variable nozzle mechanism according to any one of claims 1 to 11, wherein the exhaust gas which has passed through the scroll flow path is supplied to the turbine rotor via the variable nozzle mechanism.

In the variable capacity turbocharger with the configuration (12) described above, the fatigue damage is prevented from occurring in the portion around the inner circumference edge of the first plate on the side of the front surface. Thus, work and time required for a maintenance, such as repairing and replacing of the first plate, can be reduced.

### Advantageous Effects

At least one of embodiments of the present invention provides a variable nozzle mechanism that can prevent, for an annular plate defining an exhaust gas path in a variable nozzle mechanism, fatigue damage from occurring in a portion of the annular plate around an inner circumference edge on a side of the exhaust gas path.

### BRIEF DESCRIPTION OF DRAWINGS

FIG. 1 is a partial cross-sectional view of a variable capacity turbocharger according to one embodiment of the present invention, taken along a rotational axis.

FIG. 2 is a partially enlarged view schematically illustrating a configuration example of the variable nozzle mechanism illustrated in FIG. 1.

FIG. 3 is a partially enlarged view schematically illustrating a configuration example of the variable nozzle mechanism illustrated in FIG. 1.

FIG. 4 is a partially enlarged view schematically illustrating a configuration example of the variable nozzle mechanism illustrated in FIG. 1.

FIG. 5 is a partially enlarged view schematically illustrating a configuration example of a conventional variable nozzle mechanism.

FIG. 6 is a diagram illustrating an example of a relationship between a radial coordinate of an annular plate and temperature.

FIG. 7 is a diagram illustrating an example of a relationship between the radial coordinate of the annular plate and stress.

FIG. 8 is a diagram illustrating a state where fatigue damage is generated at a portion of the annular plate around an inner circumference edge on a side of an exhaust path.

### DETAILED DESCRIPTION

Embodiments of the present invention will now be described in detail with reference to the accompanying drawings. It is intended, however, that unless particularly specified, dimensions, materials, shapes, relative positions and the like of components described in the embodiments shall be interpreted as illustrative only and not limitative of the scope of the present invention.

For example, the expressions used herein that mean relative or absolute arrangement, such as “in a direction”, “along a direction”, in parallel with”, “orthogonal with”, “center”, and “concentrically”, mean not only exactly what they refer to but also such states that are relatively displaced with a tolerance or by an angle that is small enough to achieve the same level of functionality.

The expressions used herein that mean things are equivalent to each other, such as “the same”, “equivalent”, and “uniform”, mean not only exactly equivalent states but also such states that have a tolerance or a difference that is small enough to achieve the same level of functionality.

For example, expressions that represent shapes, such as quadrangles and cylinders, mean not only what they refer to in a geometrically strict sense but also shapes having some irregularities, chamfered portions, or the like that can provide the same level of functionality.

The expressions “including”, “comprising”, and “provided with” one component are not exclusive expressions that exclude other components.

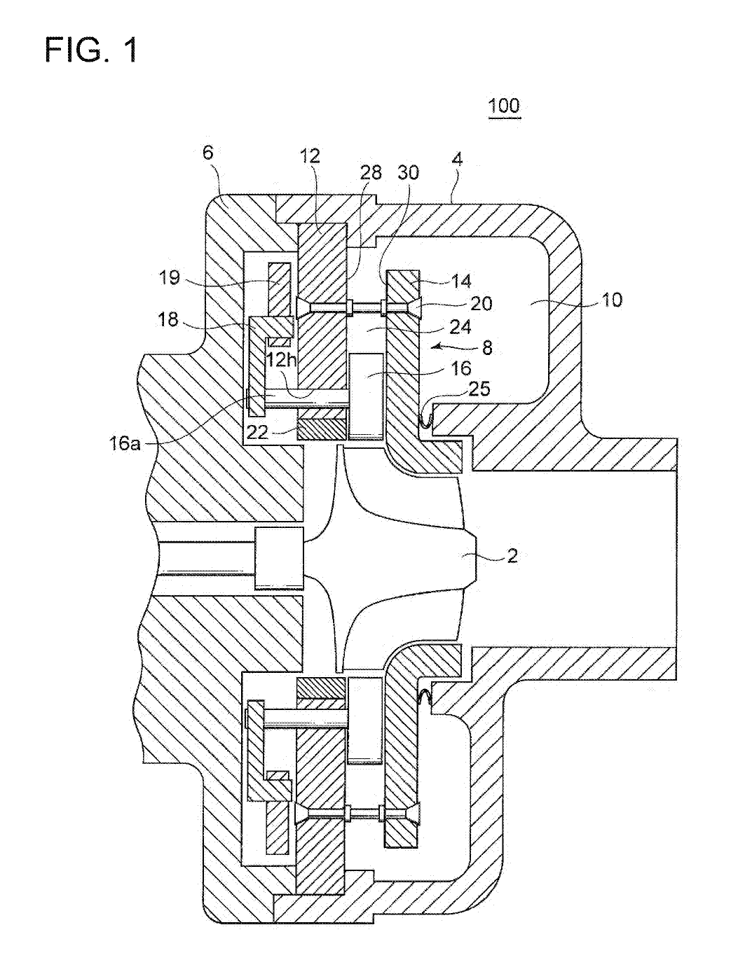

FIG. 1 is a partial cross-sectional view of a variable capacity turbocharger 100 according to one embodiment of the present invention, taken along a rotational axis.

The variable capacity turbocharger 100 includes: a turbine rotor 2 coaxially provided with an unillustrated compressor; a turbine casing 4 that accommodates the turbine rotor 2; a bearing housing 6 that rotatably supports the turbine rotor 2; and a variable nozzle mechanism 8 disposed between the turbine casing 4 and the bearing housing 6.

A scroll flow path 10 is formed in the turbine casing 4. Exhaust gas from an unillustrated engine passes through the scroll flow path 10, and then is supplied to the turbine rotor 2 through the variable nozzle mechanism 8.

The variable nozzle mechanism 8 includes a nozzle mount 12, a nozzle plate 14, a plurality of nozzle vanes 16, a plurality of lever plates 18, a drive ring 19, a plurality of nozzle supports 20, and an annular member 22.

The nozzle mount 12 is an annular plate disposed on an outer circumference side of the turbine rotor 2, and is configured to rotatably support the plurality of nozzle vanes 16. The nozzle mount 12 is provided with a plurality of supporting holes 12h (through holes) each provided for supporting a shaft portion 16a of the corresponding one of the plurality of nozzle vanes 16.

The nozzle plate 14 is an annular plate disposed while facing the nozzle mount 12, and is configured in such a manner that an exhaust gas path 24 is defined between the nozzle mount 12 and the nozzle plate 14. A spring seal 25 is provided on a side of the nozzle plate 14 opposite to the nozzle mount 12, and between the nozzle plate 14 and a turbine housing.

The nozzle mount 12 defines a hub side wall 28 of the exhaust gas path 24. The nozzle plate 14 defines a shroud side wall 30 of the exhaust gas path 24. The nozzle mount 12 and the nozzle plate 14 are coupled to each other via a nozzle support 20.

The plurality of nozzle vanes 16 are disposed between the nozzle mount 12 and the nozzle plate 14, and are rotatably supported by the nozzle mount 12. The variable nozzle mechanism 8 is configured to adjust a path area of the exhaust gas path 24 by changing an angle of the plurality of nozzle vanes 16.

In this variable nozzle mechanism 8, the drive ring 19 is drivingly rotated by driving force transmitted from an unillustrated actuator. When the drive ring 19 rotates, the lever plate 18, engaged with the drive ring 19, rotates the shaft portions 16a of the nozzle vanes 16. Thus, the nozzle vanes 16 rotate to have their angle changed.

The annular member 22 is inserted on an inner circumference side of the nozzle mount 12, with a small gap provided between an outer circumference end of the turbine rotor 2 and the annular member 22. The annular member 22 defines the hub side wall 28 of the exhaust gas path 24, together with the nozzle mount 12.

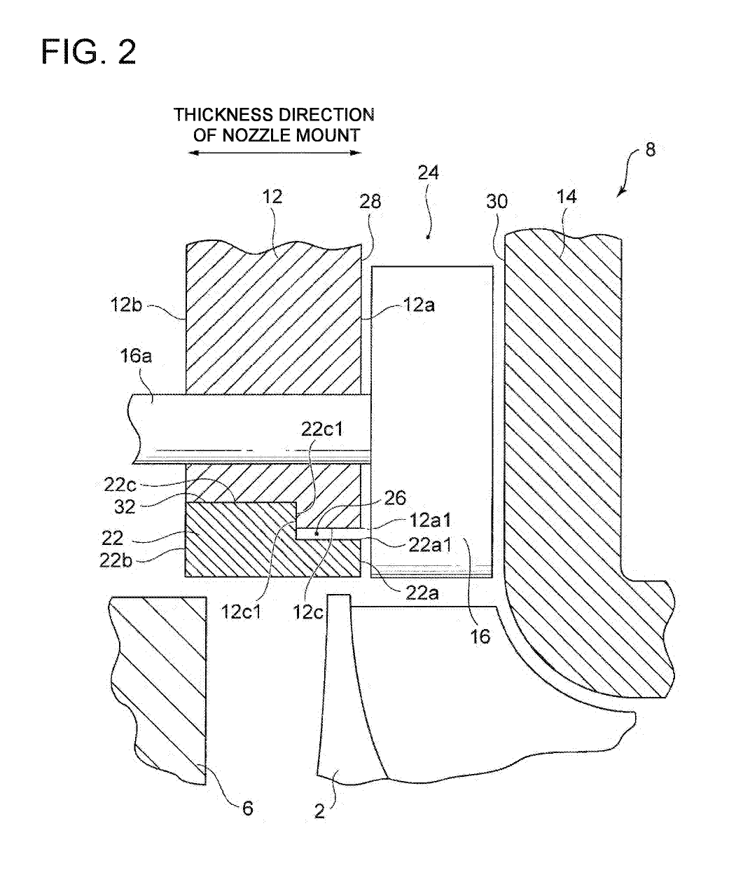

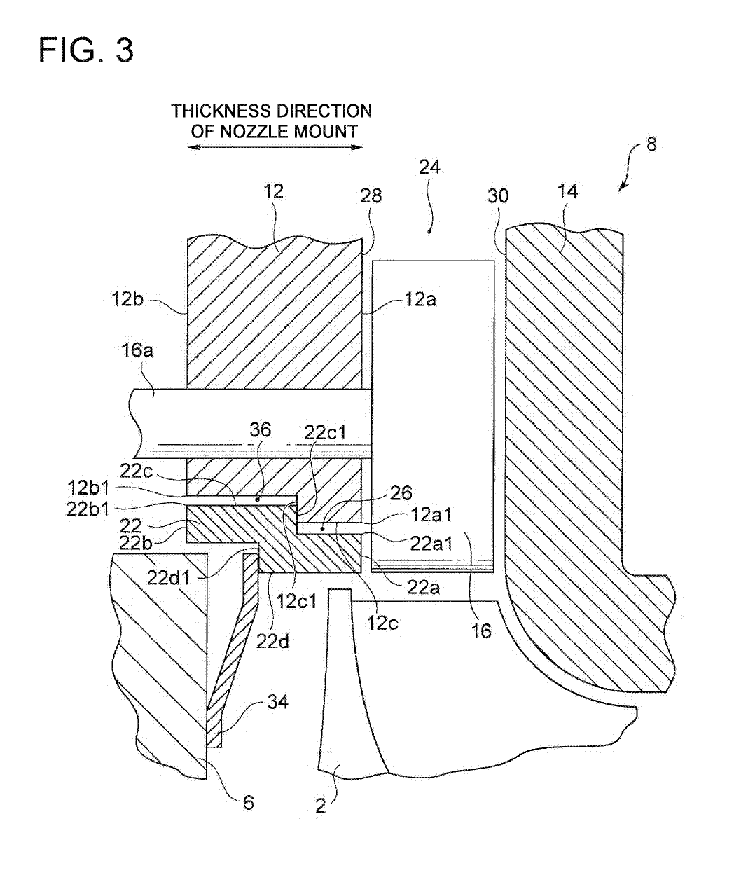

FIG. 2 is a partially enlarged view illustrating an example of a configuration of the variable nozzle mechanism illustrated in FIG. 1. FIG. 3 is a partially enlarged view illustrating an example of another configuration of the variable nozzle mechanism illustrated in FIG. 1.

In some embodiments, as illustrated in FIGS. 2 and 3, the nozzle mount 12 includes: a front surface 12a as a surface facing the exhaust gas path 24 (surface facing the nozzle plate 14) (in this specification, the term “front surface” represents “a surface on a front side”, and not “any surface” unless otherwise specified); and a back surface 12b as a surface on an opposite side to the front surface 12a. The annular member 22 includes a front surface 22a as a surface facing the exhaust gas path 24 (surface facing the nozzle plate 14); and a back surface 22b as a surface on an opposite side to the front surface 22a. In this configuration, a gap 26 is provided between the nozzle mount 12 and the annular member 22. The gap extends, along a thickness direction of the nozzle mount 12, from a point between an inner circumference edge 12a1 of the front surface 12a of the nozzle mount 12 and an outer circumference edge 22a1 of the front surface 22a of the annular member 22.

In the variable nozzle mechanism 8 illustrated in FIGS. 2 and 3, the radial temperature distribution might be largely uneven on the hub side wall (the nozzle mount 12 and the annular member 22) 28 of the exhaust gas path 24 due to the change in the temperature and flowrate of the exhaust gas caused by start/stop of an unillustrated engine or the other like load change. Even in such a case, the nozzle mount 12 and the annular member 22 thermally expand without interfering each other as long as the gap 26 is not filled. Thus, thermal stress can be effectively reduced. Thus, the fatigue damage can be prevented from occurring in the portion around the inner circumference edge 12a1 of the nozzle mount 12 on the side of the front surface 12a, even when the nozzle mount 12 and the annular member 22 are made of stainless steel featuring a lower marital strength and a lower cost than a nickel-based alloy (for example, Inconel (registered trademark)). Thus, a manufacturing cost of the variable nozzle mechanism 8 can be prevented from increasing, while preventing the fatigue damage from occurring in the portion around the inner circumference edge 12a1 of the nozzle mount 12 on the side of the front surface 12a.

In some cases the cost may not be an issue. In such a case, the nozzle mount 12 and the annular member 22 may both be made of a nickel-based alloy. Furthermore, the annular member 22 that is relatively likely to involve high thermal stress may be formed of a nickel-based alloy, and the nozzle mount 12 that is relatively less likely to involve high thermal stress may be formed of stainless steel.

In some embodiments, as illustrated in FIGS. 2 and 3 for example, a step portion 12c1 is formed entirely over the inner circumference surface 12c of the nozzle mount 12. The nozzle mount 12 has a smaller inner diameter in a portion further on a side of the front surface 12a than the step portion 12c1, than in a portion further on a side of the back surface 12b than the step portion 12c1. A step portion 22c1 is formed entirely over the outer circumference surface 22c of the annular member 22. The annular member 22 has a smaller outer diameter in a portion further on a side of the front surface 22a than the step portion 22c1, than in a portion further on a side of the back surface 22b than the step portion 22c1. The step portion 22c1 of the annular member 22 abuts against the step portion 12c1 of the nozzle mount 12 in the thickness direction of the nozzle mount 12. Thus, the annular member 22 is positioned in the thickness direction of the nozzle mount 12, and thus is prevented from falling off toward the exhaust gas path 24.

In one embodiment, as illustrated in FIG. 2 for example, the annular member 22 includes a press fitting portion 32 press fit to the nozzle mount 12, at a portion further toward the back surface 22b of the annular member 22 than the gap 26. Thus, the annular member 22 can be prevented from falling off from the nozzle mount 12 with a simple configuration, while ensuring the gap 26 provided between the nozzle mount 12 and the annular member 22.

In one embodiment, as illustrated in FIG. 2 for example, the press fitting portion 32 is press fit to the nozzle mount 12 at a portion further toward the back surface side 22b of the annular member 22 than the step portion 12c1. This ensures that the annular member 22 is prevented from falling off from the nozzle mount 12 with a simple configuration.

In one embodiment, as illustrated in FIG. 3 for example, the variable nozzle mechanism 8 includes a pressing member 34 which presses the annular member 22 toward the step portion 12c1. Thus, the annular member 22 can be prevented from falling off from the nozzle mount 12, while ensuring the gap 26 provided between the nozzle mount 12 and the annular member 22.

In one embodiment, as illustrated in FIG. 3 for example, a second gap 36 is provided between the nozzle mount 12 and the annular member 22. The second gap 36 extends to the step portion 12c1, along the thickness direction of the nozzle mount 12, from a point between the inner circumference edge 12b1 of the back surface 12b of the nozzle mount 12 and the outer circumference edge 22b1 of the back surface 22b of the annular member 22. Thus, the nozzle mount 12 and the annular member 22 are press fit to each other with the gap provided entirely over the thickness direction of the nozzle mount 12. Thus, the thermal stress can be more effectively reduced compared with the embodiment illustrated in FIG. 3, whereby the fatigue damage can be effectively prevented from occurring at an around the inner circumference surface 12 of the nozzle mount 12.

In one embodiment, as illustrated in FIG. 3 for example, the inner circumference surface 22d of the annular member 22 is provided with a step portion 22d1. The annular member 22 has a larger diameter in a portion further on a side of the front surface 22a than the step portion 22d1, than in a portion further on a side of the back surface 22b than the step portion 22d1. The pressing member 34 is configured to press the annular member 22 while having one end side supported by the bearing housing 6 and the other end side in contact with the step portion 22d1. Thus, the annular member 22 can be stably supported on the inner circumference side of the nozzle mount 12. For example, the pressing member 34 may be a spring plate having an annular shape.

In some embodiments, in the variable nozzle mechanism 8 illustrated in FIGS. 2 to 4 for example, a material forming the annular member 22 may have a smaller linear expansion coefficient than a material forming the nozzle mount 12. For example, this condition on the difference in the linear expansion coefficient holds true when the nozzle mount 12 is formed of stainless steel and the annular member 22 is formed of a nickel-based alloy.

Thus, even when the temperature of the annular member 22 temporarily exceeds the nozzle mount 12 due the operation of the unillustrated engine, the thermal stress can be prevented from increasing with the difference between the annular member 22 and the nozzle mount 12 in a thermal deformation amount prevented from increasing. Thus, the fatigue damage can be prevented from occurring in a portion around the inner circumference edge 12a1 of the nozzle mount 12.

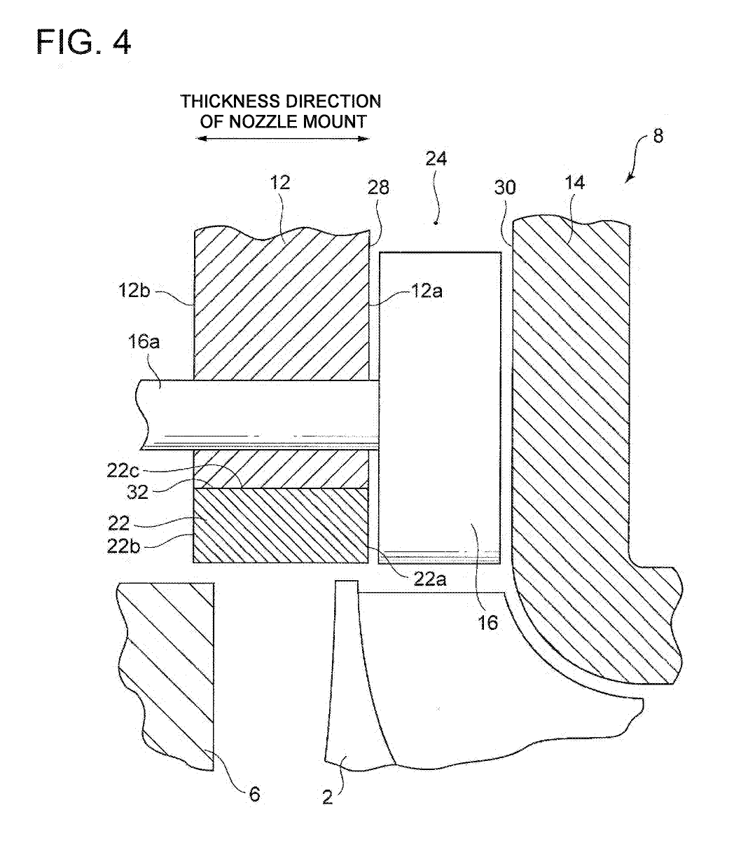

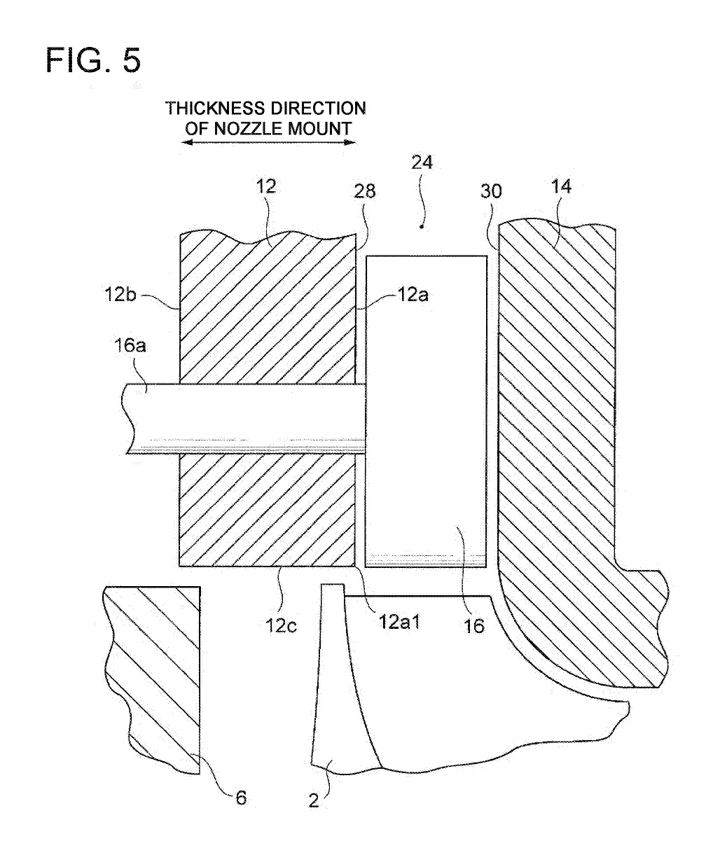

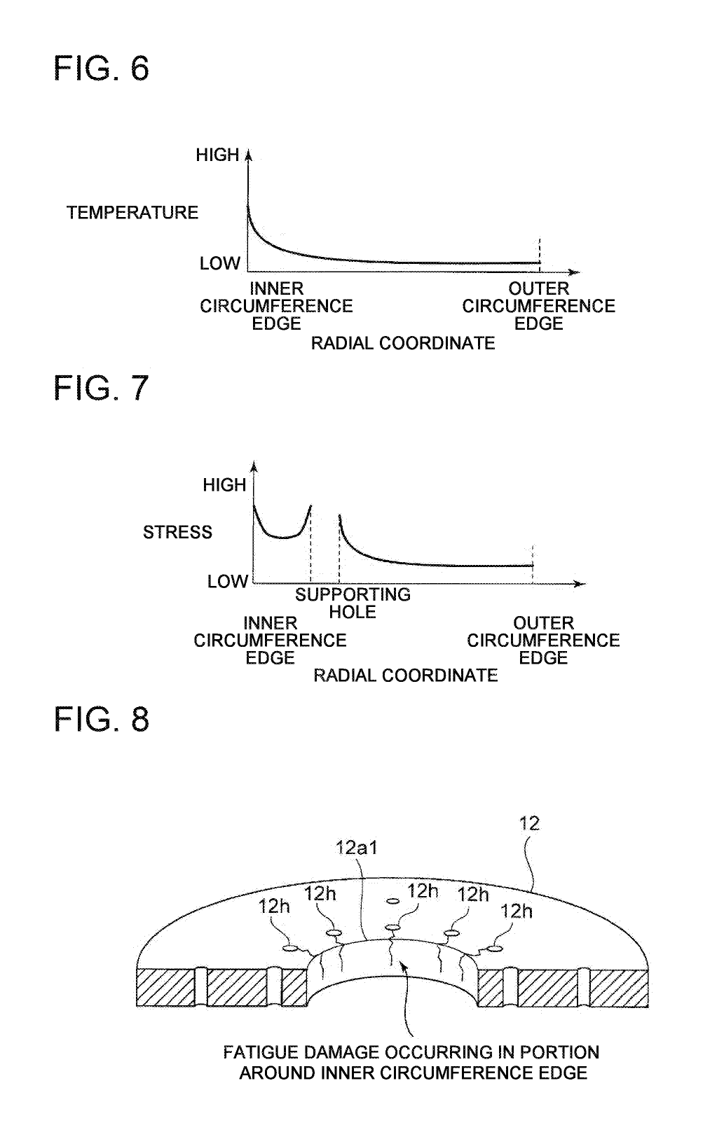

The variable nozzle mechanism 8 illustrated in FIG. 4 is not provided with the gap 26 illustrated in FIGS. 2 and 3. Even in such a configuration, the fatigue damage can be prevented from occurring in the portion around the inner circumference edge 12a1 of the nozzle mount 12, when the material forming the annular member 22 has a smaller linear expansion coefficient than the material forming the nozzle mount 12. Still, the fatigue damage might not be sufficiently prevented from occurring only by setting the liner expansion coefficient of the annular member 22 to be smaller than that of the nozzle mount 12, when a temperature difference between the nozzle mount 12 and the annular member 22 due to the operation of the unillustrated engine is large.

In view of this, in the variable nozzle mechanism 8 illustrated FIGS. 2 and 3, the fatigue damage can be easily prevented from occurring by appropriately setting the length of the gap 26 in the thickness direction of the nozzle mount 12 and the radial direction. For example, the length of the gap 26 in the thickness direction of the nozzle mount 12 (depth) is in a range of 1/10 to less than 1, and may preferably be in a range of ½ to less than ¾, of the thickness of the nozzle mount 12 (or the length of the annular member 22 in the thickness direction of the nozzle mount). For example, the length of the gap 26 in the radial direction of the nozzle mount 12 may be equal to or longer than 10 μm and may preferably be equal to or longer than 50 μm.

The present invention is not limited to the embodiment described above, and includes a mode obtained by modifying the embodiment described above and a mode obtained by appropriately combining the modes.

For example, not only the nozzle mount 12 but also the nozzle plate 14 is exposed to the high temperature exhaust gas while the unillustrated engine is operating. Thus, when the temperature and the flowrate of the exhaust gas change due to star/stop of the engine or the other like load change, the radial temperature distribution of the nozzle plate 14 becomes largely uneven. Thus, the annular member 22 may be inserted on the inner circumference side of the nozzle plate 14 as in the case of the nozzle mount 12, whereby the fatigue damage can be prevented from occurring in a portion around the inner circumference edge of the nozzle plate 14.

### REFERENCE SIGNS LIST

2 Turbine rotor
4 Turbine casing
6 Bearing housing
8 Variable nozzle mechanism
10 Scroll flow path
12 Nozzle mount (annular plate)
12a Front surface
12a1 Inner circumference edge
12b Back surface
12b1 Inner circumference edge
12c Inner circumference surface
12c1 Step portion
12h Supporting hole
14 Nozzle plate (annular plate)
16 Nozzle vane
16a Shaft portion
18 Lever plate
19 Drive ring
20 Nozzle support
22 Annular member
22a Front surface
22a1 Outer circumference edge
22b Back surface
22b1 Outer circumference edge
22c Outer circumference surface
22c1 Step portion
22d Inner circumference surface
22d1 Step portion
24 Exhaust gas path
25 Spring seal
26 Gap
28 Hub side wall
30 Shroud side wall
32 Press fitting portion
34 Pressing member
36 Second gap
100 Variable capacity turbocharger

1.-12. (canceled)

13. A variable nozzle mechanism for a variable capacity turbocharger, the variable nozzle mechanism comprising:
a first plate having an annular shape;
a second plate facing the first plate and having an annular shape, the second plate and the first plate defining an exhaust gas path in between;
a plurality of nozzle vanes rotatably supported between the first plate and the second plate; and
an annular member inserted on an inner circumference side of the first plate, wherein
the first plate includes a front surface facing the exhaust gas path and a back surface on an opposite side to the front surface,
the annular member includes a front surface facing the exhaust gas path and a back surface on an opposite side to the front surface,
a gap is provided between the first plate and the annular member, the gap extending along a thickness direction of the first plate, from a point between an inner circumference edge of the front surface of the first plate and an outer circumference edge of the front surface of the annular member, and
the annular member includes a press fitting portion which is press fit to the first plate, at a portion further toward a side of the back surface of the annular member than the gap.

14. The variable nozzle mechanism according to claim 13, wherein
the first plate has an inner circumference surface provided with a step portion against which the annular member abuts in the thickness direction of the first plate, and
the press fitting portion is press fit to the first plate at a portion further toward the side of the back surface of the annular member than the step portion.

15. A variable nozzle mechanism for a variable capacity turbocharger, the variable nozzle mechanism comprising:
a first plate having an annular shape;
a second plate facing the first plate and having an annular shape, the second plate and the first plate defining an exhaust gas path in between;
a plurality of nozzle vanes rotatably supported between the first plate and the second plate; and
an annular member inserted on an inner circumference side of the first plate, wherein
the first plate includes a front surface facing the exhaust gas path and a back surface on an opposite side to the front surface,
the annular member includes a front surface facing the exhaust gas path and a back surface on an opposite side to the front surface,
a gap is provided between the first plate and the annular member, the gap extending along a thickness direction of the first plate, between an inner circumference edge of the front surface of the first plate and an outer circumference edge of the front surface of the annular member,
the first plate has an inner circumference surface provided with a step portion against which the annular member abuts in the thickness direction of the first plate, and
the variable nozzle mechanism further includes a pressing member which presses the annular member toward the step portion.

16. The variable nozzle mechanism according to claim 15, wherein a second gap is provided between the first plate and the annular member, the second gap extending along the thickness direction of the first plate, to the step portion from a point between the inner circumference edge of the back surface of the first plate and the outer circumference edge of the back surface of the annular member.

17. The variable nozzle mechanism according to claim 14, wherein the step portion is formed entirely over the inner circumference surface of the first plate.

18. The variable nozzle mechanism according to claim 13, wherein the first plate and the annular member are made of stainless steel.

19. The variable nozzle mechanism according to claim 13, wherein
the first plate is a nozzle mount defining a hub side wall of the exhaust gas path,
the second plate is a nozzle plate defining a shroud side wall of the exhaust gas path, and
the first plate is provided with a plurality of supporting holes each rotatably supporting a shaft portion of a corresponding one of the plurality of nozzle vanes.

20. The variable nozzle mechanism according to claim 19, wherein a material forming the annular member has a smaller linear expansion coefficient than a material forming the first plate.

21. The variable nozzle mechanism according to claim 20, wherein the annular member is made of a nickel-based alloy and the first plate is made of stainless steel.

22. A variable nozzle mechanism for a variable capacity turbocharger, the variable nozzle mechanism comprising:
a first plate having an annular shape;
a second plate facing the first plate and having an annular shape, the second plate and the first plate defining an exhaust gas path in between;
a plurality of nozzle vanes rotatably supported between the first plate and the second plate; and
an annular member inserted on an inner circumference side of the first plate, wherein
the first plate is a nozzle mount defining a hub side wall of the exhaust gas path,
the second plate is a nozzle plate defining a shroud side wall of the exhaust gas path,
the first plate is provided with a plurality of supporting holes each rotatably supporting a shaft portion of a corresponding one of the plurality of nozzle vanes, and
a material forming the annular member has a smaller linear expansion coefficient than a material forming the first plate.

23. The variable capacity turbocharger comprising:
a turbine rotor;
a turbine housing which accommodates the turbine rotor, and defines a scroll flow path into which exhaust gas from an engine flows; and
the variable nozzle mechanism according to claim 13, wherein
the exhaust gas which has passed through the scroll flow path is supplied to the turbine rotor via the variable nozzle mechanism.
